(19) United States
(12) Patent Application Publication
(10) Pub. No.: US 2024/0359209 A1
(43) Pub. Date: Oct. 31, 2024

(54) COATING STRUCTURE

(71) Applicant: KABUSHIKI KAISHA TOKAI-RIKA-DENKI-SEISAKUSHO, Niwa-gun (JP)

(72) Inventors: Reiya ICHIMURA, Aichi (JP); Satoshi ITO, Aichi (JP)

(21) Appl. No.: 18/640,777

(22) Filed: Apr. 19, 2024

(30) Foreign Application Priority Data
Apr. 25, 2023 (JP) 2023-071830

(51) Int. Cl. B05D 5/02

(52) U.S. Cl. CPC B05D 5/02

(57) ABSTRACT

A coating structure is provided with embossed portions on a base surface of a substrate, with a coating material layer covering the base surface. A depth of the embossed portions in a one-side area is larger than a depth of the embossed portions in an intermediate area, and on a surface of the coating material layer, a depth of one-side indentations and projections in the one-side area is larger than a depth of intermediate indentations and projections in the intermediate area.

### CROSS-REFERENCE TO RELATED APPLICATION

This application claims priority under 35 USC 119 from Japanese Patent Application No. 2023-071830 filed Apr. 25, 2023, the disclosure of which is incorporated by reference herein in its entirety.

### BACKGROUND

### Technical Field

The present disclosure relates to a coating structure of a substrate covered with a coating material layer.

### Related Art

A front bumper described in Japanese Patent Application Laid-Open (JP-A) No. H05-253533 is provided with a non-coated portion and a coated portion on a surface of a resin member.

In the front bumper, the non-coated portion is masked with tape, and the coated portion is coated.

### SUMMARY

In consideration of the above circumstances, the present disclosure is to obtain a coating structure capable of changing design of a coating material layer surface without masking.

A coating structure of a first aspect of the present disclosure includes: a substrate that has a base surface at which base surface indentations and projections are provided, a first area and a second area being provided on the base surface such that the first area is adjacent to the second area, and a depth of the base surface indentations and projections in the first area being larger than a depth of the base surface indentations and projections in the second area; and a coating material layer that is formed from a single coating material and that covers the base surface, a depth of first indentations and projections corresponding to the base surface indentations and projections at a surface of the coating material layer, which surface corresponds to the first area, being larger than a depth of second indentations and projections corresponding to the base surface indentations and projections at a surface of the coating material layer, which surface corresponds to the second area.

A coating structure of a second aspect of the present disclosure is the coating structure of the first aspect of the present disclosure, wherein a third area is provided on the base surface, a depth of the base surface indentations and projections in the third area is smaller than the depth of the base surface indentations and projections in the first area and larger than the depth of the base surface indentations and projections in the second area, and a depth of third indentations and projections corresponding to the base surface indentations and projections at a surface of the coating material layer, which surface corresponds to the third area, is smaller than the depth of the first indentations and projections and larger than the depth of the second indentations and projections.

A coating structure of a third aspect of the present disclosure includes: a substrate that has a base surface at which base surface indentations and projections are provided, a first area and a second area being provided on the base surface such that the first area is adjacent to the second area, and a depth of the base surface indentations and projections in the first area being larger than a depth of the base surface indentations and projections in the second area; and a coating material layer that is formed from a single coating material and that covers the base surface, front indentations and projections corresponding to the base surface indentations and projections being provided on a surface of the coating material layer, which surface corresponds to the first area, and the front indentations and projections corresponding to the base surface indentations and projections not being provided on a surface of the coating material layer, which surface corresponds to the second area.

A coating structure of a fourth aspect of the present disclosure includes: a substrate that has a base surface at which base surface indentations and projections are provided, a first area and a second area being provided on the base surface such that the first area is adjacent to the second area, and a spacing of the base surface indentations and projections in the first area being larger than a spacing of the base surface indentations and projections in the second area; and a coating material layer that is formed from a single coating material and that covers the base surface, a depth of first indentations and projections corresponding to the base surface indentations and projections at a surface of the coating material layer, which surface corresponds to the first area, being larger than a depth of second indentations and projections corresponding to the base surface indentations and projections at a surface of the coating material layer, which surface corresponds to the second area.

A coating structure of a fifth aspect of the present disclosure is the coating structure of the fourth aspect of the present disclosure, wherein a third area is provided on the base surface, a spacing of the base surface indentations and projections in the third area is smaller than the spacing of the base surface indentations and projections in the first area and larger than the spacing of the base surface indentations and projections in the second area, and a depth of third indentations and projections corresponding to the base surface indentations and projections at a surface of the coating material layer, which surface corresponds to the third area, is smaller than the depth of the first indentations and projections and larger than the depth of the second indentations and projections.

A coating structure of a sixth aspect of the present disclosure includes: a substrate that has a base surface at which base surface indentations and projections are provided, a first area and a second area being provided on the base surface such that the first area is adjacent to the second area, and a spacing of the base surface indentations and projections in the first area being larger than a spacing of the base surface indentations and projections in the second area; and a coating material layer that is formed from a single coating material and that covers the base surface, front indentations and projections corresponding to the base surface indentations and projections being provided on a surface of the coating material layer, which surface corresponds to the first area, and the front indentations and projections corresponding to the base surface indentations and projections not being provided on a surface of the coating material layer, which surface corresponds to the second area.

A coating structure of a seventh aspect of the present disclosure is the coating structure of any one of the first aspect to the sixth aspect of the present disclosure, wherein the coating material layer is formed from a matt coating material.

In the coating structure of the first aspect of the present disclosure, the base surface indentations and projections are provided to the base surface of the substrate, and the coating material layer is formed from the single coating material and covers the base surface.

The first area and the second area of the base surface are adjacent, the depth of the base surface indentations and projections is large in the first area of the base surface, and the depth of the base surface indentations and projections is small in the second area of the base surface. In the coating material layer, the depth is large for the first indentations and projections corresponding to the base surface indentations and projections on the surface corresponding to the first area, and the depth is small for the second indentations and projections corresponding to the base surface indentations and projections on the surface corresponding to the second area. This accordingly enables a design (styling) difference to be achieved in the coating material layer between the surface corresponding to the first area and the surface corresponding to the second area, enabling a change in the design of the coating material layer surface even without using masking.

In the coating structure of the second aspect of the present disclosure, the depth of the base surface indentations and projections in the third area on the base surface is smaller than in the first area and larger than in the second area, with the depth of the third indentations and projections corresponding to the base surface indentations and projections on the surface corresponding to the third area of the coating material layer being a depth intermediate between the depths of the first indentations and projections and the second indentations and projections. This enables a different to be achieved in design in the coating material layer between the surface corresponding to the first area, the surface corresponding to the second area, and the surface corresponding to the third area.

In the coating structure of the third aspect of the present disclosure, the base surface indentations and projections are provided to the base surface of the substrate, and the coating material layer is formed from the single coating material and covers the base surface.

The first area and the second area of the base surface are adjacent, the depth is large of the base surface indentations and projections in the first area of the base surface and the depth is small of the base surface indentations and projections in the second area of the base surface, and in the coating material layer, the front indentations and projections corresponding to the base surface indentations and projections are provided on the surface corresponding to the first area and the front indentations and projections corresponding to the base surface indentations and projections are not provided to the surface corresponding to the second area. This thereby enables a different to be achieved in the design in the coating material layer between the surface corresponding to the first area and the surface corresponding to the second area, enabling a change in design of the coating material layer surface even without using masking.

In the coating structure of the fourth aspect of the present disclosure, the base surface indentations and projections are provided to the base surface of the substrate, and the coating material layer is formed from the single coating material, and covers the base surface.

The first area and the second area of the base surface are adjacent, the spacing of the base surface indentations and projections is large in the first area of the base surface, and the spacing of the base surface indentations and projections is small in the second area of the base surface. In the coating material layer, the depth is large of the first indentations and projections corresponding to the base surface indentations and projections on the surface corresponding to the first area, and the depth is small of the second indentations and projections corresponding to the base surface indentations and projections on the surface corresponding to the second area. This means that the design can be made different in the coating material layer between the surface corresponding to the first area and the surface corresponding to the second area, enabling a change in design of the coating material layer surface even without using masking.

In the coating structure of the fifth aspect of the present disclosure, the spacing of the base surface indentations and projections in the third area on the base surface is smaller than in the first area and larger than in the second area, with the depth of the third indentations and projections corresponding to the base surface indentations and projections on the surface corresponding to the third area of the coating material layer being a depth intermediate between the depths of the first indentations and projections and the second indentations and projections. This accordingly enables a different to be achieved in design in the coating material layer between the surface corresponding to the first area, the surface corresponding to the second area, and the surface corresponding to the third area.

In the coating structure of the sixth aspect of the present disclosure, the base surface indentations and projections are provided to the base surface of the substrate, and the coating material layer is formed from the single coating material and covers the base surface.

The first area and the second area of the base surface are adjacent, the spacing of the base surface indentations and projections is large in the first area of the base surface, and the spacing of the base surface indentations and projections is small in the second area of the base surface. In the coating material layer, the front indentations and projections corresponding to the base surface indentations and projections are provided to the surface corresponding to the first area and the front indentations and projections corresponding to the base surface indentations and projections are not provided to the surface corresponding to the second area. This means that the design can be made different in the coating material layer between the surface corresponding to the first area and the surface corresponding to the second area, enabling a change in design of the coating material layer surface even without using masking.

In the coating structure of the seventh aspect of the present disclosure, the coating material layer is formed from the matt coating material. This thereby enables a large difference to be achieved in the design of the coating material layer surface by the difference in the depth of the surface indentations and projections of the coating material layer.

### BRIEF DESCRIPTION OF THE DRAWINGS

FIG. 1A and FIG. 1B are diagrams illustrating a coating structure according to a first exemplary embodiment of the present disclosure, wherein FIG. 1A is a plan view and FIG. 1B is a cross-section (a cross-section taken along line 1B-1B of FIG. 1A).

FIG. 2A and FIG. 2B are diagrams illustrating a coating structure according to a second exemplary embodiment of the present disclosure, wherein FIG. 2A is a plan view, and FIG. 2B is a cross-section (a cross-section taken along line 2B-2B of FIG. 2A).

FIG. 3 is a graph illustrating a relationship of a depth or spacing of embossed portions to a glossiness of the coating material layer surface in a coating structure according to the first exemplary embodiment or the second exemplary embodiment of the present disclosure.

### DETAILED DESCRIPTION

### First Exemplary Embodiment

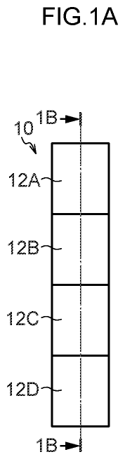

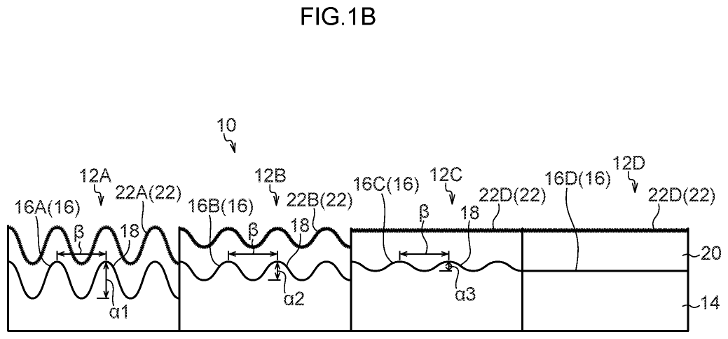

FIG. 1A is a plan view illustrating a coating structure 10 according to a first exemplary embodiment of the present disclosure, and FIG. 1B is a cross-section of the coating structure 10 (a cross-section taken along line 1B-1B of FIG. 1A).

The coating structure 10 according to the present exemplary embodiment is, for example, applied to a design member of a vehicle.

As illustrated in FIG. 1A and FIG. 1B, the coating structure 10 is provided with a one-side area 12A, an intermediate area 12B, an other-side area 12C, and an additional area 12D. The one-side area 12A and the intermediate area 12B are adjacent, the intermediate area 12B and the other-side area 12C are adjacent, and the other-side area 12C and the additional area 12D are adjacent.

A substrate 14 is provided in the coating structure 10, and the substrate 14 is, for example, made from resin. A surface of the substrate 14 is a base surface 16, and embossed portions 18 serving as base surface indentations and projections (concave portions and convex portions) are formed to the base surface 16.

The base surface 16 in the one-side area 12A is a one-side base surface area 16A serving as first area, and the same embossed portions 18 are formed uniformly in the one-side base surface area 16A, with a depth (dimension in height direction from a lowest height position of the indentation to a highest height position of the projection) of the embossed portion 18 of α1 (for example 50 micrometer (μm)), and a spacing of the embossed portions 18 (a distance between highest height positions of the adjacent projections or between lowest height positions of the adjacent indentations) of β.

The base surface 16 in the intermediate area 12B is an intermediate base surface area 16B serving as first area, second area or third area, and the same embossed portions 18 are formed uniformly in the intermediate base surface area 16B, with a depth of the embossed portion 18 of α2 (for example 30 μm), which is smaller than α1, and a spacing of the embossed portions 18 of β.

The base surface 16 in the other-side area 12C is an other-side base surface area 16C serving as second area, and the same embossed portions 18 are formed uniformly in the other-side base surface area 16C, with a depth of the embossed portion 18 of α3 (for example 10 μm), which is smaller than α2, and a spacing of the embossed portions 18 of β.

The base surface 16 in the additional area 12D is an additional base surface area 16D, with embossed portions 18 not formed in the additional base surface area 16D.

As described above, the depth of the embossed portions 18 is larger in the one-side base surface area 16A than in the intermediate base surface area 16B, and is larger in the intermediate base surface area 16B than in the other-side base surface area 16C. Furthermore, the spacings of the embossed portions 18 are the same in the one-side base surface area 16A, the intermediate base surface area 16B, and the other-side base surface area 16C. Moreover, highest height positions of the embossed portions 18 are the same or substantially the same in the one-side base surface area 16A, the intermediate base surface area 16B, and the other-side base surface area 16C.

The front face of the base surface 16 of the substrate 14 is coated with a single (same) coating material such that the front face of the base surface 16 is covered by a coating material layer 20. The coating material of the coating material layer 20 is, for example, an opaque (non-transparent) matt coating material, and surface indentations and projections 22 are formed on the surface of the coating material layer 20.

At the surface of the coating material layer 20, the same one-side indentations and projections 22A, which are surface indentations and projections 22 (first indentations and projections, front indentations and projections), are formed uniformly in the one-side area 12A, and the one-side indentations and projections 22A are induced (caused) by the embossed portions 18 in the one-side base surface area 16A of the base surface 16 of the substrate 14, and have a shape corresponding to these embossed portions 18 (a shape substantially following these embossed portions 18, a shape having indention portions and projection portions corresponding to the indention portions and the projection portions of these embossed portions 18).

At the surface of the coating material layer 20, the same intermediate indentations and projections 22B, which are surface indentations and projections 22 (first indentations and projections, second indentations and projections, third indentations and projections, front indentations and projections), are formed uniformly in the intermediate area 12B, and the intermediate indentations and projections 22B are induced by the embossed portions 18 in the intermediate base surface area 16B on the base surface 16 of the substrate 14, and have a shape corresponding to these embossed portions 18 (a shape substantially following these embossed portions 18).

At the surface of the coating material layer 20, substantially the same other-side indentations and projections 22C, which are surface indentations and projections 22, are formed uniformly in the other-side area 12C, and the other-side indentations and projections 22C are induced by particles of the coating material and are not induced by the embossed portions 18 in the other-side base surface area 16C on the base surface 16 of the substrate 14, and have a shape that does not correspond to these embossed portions 18 (a shape that does not follow these embossed portions 18, (a shape substantially following these embossed portions 18, a shape not having indention portions and projection portions corresponding to the indention portions and the projection portions of these embossed portions 18).

At the surface of the coating material layer 20, substantially the same additional indentations and projections 22D, which are surface indentations and projections 22, are formed uniformly in the additional area 12D. Due to the embossed portions 18 not being formed in the additional base surface area 16D of the base surface 16 of the substrate 14, the additional indentations and projections 22D are induced by particles of the coating material and have the same shape as the other-side indentations and projections 22C.

Similar to the other-side indentations and projections 22C and the additional indentations and projections 22D, indentations and projections that are induced by particles of the coating material are also provided on the one-side indentations and projections 22A and on the intermediate indentations and projections 22B.

As above, the depth of the one-side indentations and projections 22A (dimension in height direction from a lowest height position of the indentation to a highest height position of the projection) is larger than the depth of the intermediate indentations and projections 22B, the depth of the intermediate indentations and projections 22B is larger than the depth of the other-side indentations and projections 22C and the depth of the additional indentations and projections 22D. The visibility of the surface indentations and projections 22 becomes high and the gloss (glossiness) of the surface of the coating material layer 20 becomes low as the depth of the surface indentations and projections 22 increases. The highest height positions of the one-side indentations and projections 22A, the intermediate indentations and projections 22B, the other-side indentations and projections 22C, and the additional indentations and projections 22D are the same or substantially the same as each other.

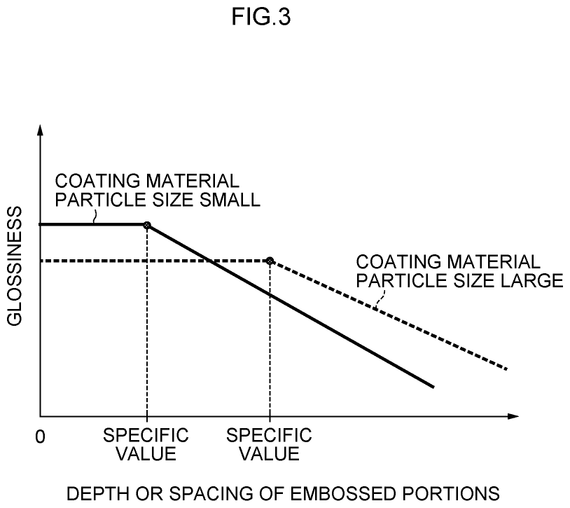

As illustrated in FIG. 3, in cases in which the depth of the embossed portions 18 on the base surface 16 of the substrate 14 is less than specific value (in cases with the other-side area 12C and the additional area 12D), the surface indentations and projections 22 are not formed by the embossed portions 18 on the surface of the coating material layer 20, and the gloss of the surface of the coating material layer 20 is accordingly high. On the other hand, in cases in which the depth of the embossed portions 18 is the specific value or larger (in cases with the one-side area 12A and the intermediate area 12B), the surface indentations and projections 22 are formed by the embossed portions 18 on the surface of the coating material layer 20, and the depth of the surface indentations and projections 22 becomes large following the larger depth of the embossed portions 18, leading to the gloss of the surface of the coating material layer 20 becoming low. Moreover, the specific value is smaller as the particle size of the coating material of the coating material layer 20 becomes smaller, facilitating the surface indentations and projections 22 being formed by the embossed portions 18 on the surface of the coating material layer 20. Note that gap between particles of the coating material become larger as the particle size of the coating material of the coating material layer 20 becomes larger, with the embossed portions 18 being buried in (hidden by) these gaps, with the surface indentations and projections 22 becoming difficult to be formed by the embossed portions 18 on the surface of the coating material layer 20.

Next, description follows regarding operation of the present exemplary embodiment.

In the coating structure 10 configured as described above, the embossed portions 18 are provided to the base surface 16 of the substrate 14, the coating material layer 20 is formed by a single coating material and covers the base surface 16.

The depth of the embossed portions 18 in the one-side area 12A (the one-side base surface area 16A) is larger than the depth of the embossed portions 18 in the intermediate area 12B (the intermediate base surface area 16B), and at the surface of the coating material layer 20, the depth of the one-side indentations and projections 22A corresponding to the embossed portions 18 in the one-side area 12A is larger than the depth of the intermediate indentations and projections 22B corresponding to the embossed portions 18 in the intermediate area 12B. Therefore, by making the visibility of the one-side indentations and projections 22A of the one-side area 12A greater than the visibility of the intermediate indentations and projections 22B of the intermediate area 12B, a difference can be achieved in design (styling) in the coating material layer 20 between the surface of the one-side area 12A and the surface of the intermediate area 12B, enabling a change in design of the surface of the coating material layer 20 to be achieved even without using masking, and also enabling a change in design of the surface of the coating material layer 20 to be achieved even without using plural types of coating material, thereby facilitating a reduction in cost.

Furthermore, the one-side base surface area 16A and the intermediate base surface area 16B are adjacent on the base surface 16 of the substrate 14, and the one-side indentations and projections 22A and the intermediate indentations and projections 22B are adjacent on the surface of the coating material layer 20. Therefore, a parting portion (boundary) can be provided in the coating material layer 20 between the surface of the one-side area 12A and the surface of the intermediate area 12B. Moreover, the parting portion can be provided without using masking, enabling elimination of the need to provide an indentation portion along an outer perimeter of the masking on the base surface 16, enabling sharpness to be achieved in the parting portion, and enabling a highly attractive parting portion.

Moreover, a depth of the embossed portions 18 in the intermediate area 12B (the intermediate base surface area 16B) is larger than the depth of the embossed portions 18 in the other-side area 12C (the other-side base surface area 16C), and at the surface of the coating material layer 20 a depth of the intermediate indentations and projections 22B corresponding to the embossed portions 18 in the intermediate area 12B is larger than the depth of the other-side indentations and projections 22C not corresponding to the embossed portions 18 in the other-side area 12C. Therefore, by making the visibility of the intermediate indentations and projections 22B of the intermediate area 12B greater than the visibility of the other-side indentations and projections 22C of the other-side area 12C, a difference can be achieved in the design in the coating material layer 20 between the surface of the intermediate area 12B and the surface of the other-side area 12C, enabling a change in design of the surface of the coating material layer 20 to be achieved even without using masking, and also enabling a change in design of the surface of the coating material layer 20 to be achieved even without using plural types of coating material, thereby facilitating a reduction in cost.

Furthermore, the intermediate base surface area 16B and the other-side base surface area 16C are adjacent on the base surface 16 of the substrate 14, and the intermediate indentations and projections 22B and the other-side indentations and projections 22C are adjacent on the surface of the coating material layer 20. Therefore, a parting portion (boundary) can be provided in the coating material layer 20 between the surface of the intermediate area 12B and the surface of the other-side area 12C. Moreover, the parting portion can be provided without using masking, enabling elimination of the need to provide an indentation portion along an outer perimeter of the masking on the base surface 16, enabling sharpness to be achieved in the parting portion, and enabling a highly attractive parting portion.

Moreover, a depth of the embossed portions 18 in the one-side area 12A (the one-side base surface area 16A) is larger than the depth of the embossed portions 18 in the other-side area 12C (the other-side base surface area 16C), and at the surface of the coating material layer 20 a depth of the one-side indentations and projections 22A corresponding to the embossed portions 18 in the one-side area 12A is larger than the depth of the other-side indentations and projections 22C not corresponding to the embossed portions 18 in the other-side area 12C. Therefore, by making the visibility of the one-side indentations and projections 22A of the one-side area 12A greater than the visibility of the other-side indentations and projections 22C of the other-side area 12C, a difference can be achieved in the design in the coating material layer 20 between the surface of the one-side area 12A and the surface of the other-side area 12C, enabling a change in design of the surface of the coating material layer 20 to be achieved even without using masking, and also enabling a change in design of the surface of the coating material layer 20 to be achieved even without using plural types of coating material, thereby facilitating a reduction in cost.

Furthermore, the coating material layer 20 is formed by the matt coating material. Therefore, a large difference can be achieved in the design of the surface of the coating material layer 20 due to the difference in the depth of the surface indentations and projections 22 of the coating material layer 20. Moreover, suppose that the coating material layer 20 were to peel off due to abrasion or the like, high gloss of the surface of the coating structure 10 can be suppressed by the embossed portions 18 on the base surface 16 of the substrate 14.

### Second Exemplary Embodiment

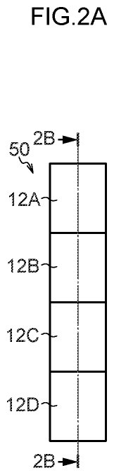

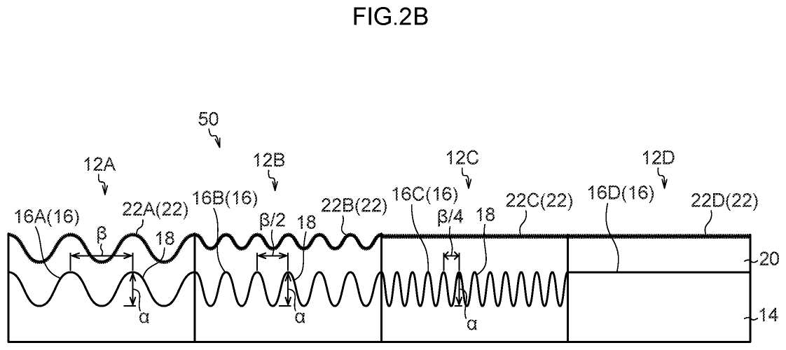

FIG. 2A is a plan view illustrating a coating structure 50 according to a second exemplary embodiment of the present disclosure, and FIG. 2B is a cross-section of the coating structure 50 (a cross-section taken along line 2B-2B of FIG. 2A).

The coating structure 50 according to the present exemplary embodiment is configured substantially the same as the first exemplary embodiment described above, but differs in the following points.

As illustrated in FIG. 2A and FIG. 2B, in the coating structure 50 according to the present exemplary embodiment, at the one-side base surface area 16A of the base surface 16 of the substrate 14, the depth (dimension in height direction from a lowest height position of the indentation to a highest height position of the projection) of the embossed portion 18 is α (for example, 30 μm) and the spacing of the embossed portions 18 is β.

In the intermediate base surface area 16B of the base surface 16 of the substrate 14, the depth of the embossed portion 18 is α and the spacing of the embossed portions 18 is β/2.

In the other-side area 12C of the base surface 16 of the substrate 14, the depth of the embossed portion 18 is α and the spacing of the embossed portions 18 is β/4.

The above means that the depths of the embossed portions 18 are the same across the one-side base surface area 16A, the intermediate base surface area 16B, and the other-side base surface area 16C. Furthermore, the spacing of the embossed portions 18 is larger in the one-side base surface area 16A than in the intermediate base surface area 16B, and is also larger in the intermediate base surface area 16B than in the other-side base surface area 16C. Moreover, the highest height positions and the lowest height positions of the embossed portions 18 are the same or substantially the same across the one-side base surface area 16A, the intermediate base surface area 16B, and the other-side base surface area 16C.

At the surface of the coating material layer 20, the same one-side indentations and projections 22A, which are surface indentations and projections 22, are formed uniformly in the one-side area 12A, the one-side indentations and projections 22A are induced by the embossed portions 18 in the one-side base surface area 16A of the base surface 16 of the substrate 14 and have a shape corresponding to these embossed portions 18 (a shape substantially following the embossed portions 18).

At the surface of the coating material layer 20, the same intermediate indentations and projections 22B, which are surface indentations and projections 22, are formed uniformly in the intermediate area 12B, the intermediate indentations and projections 22B are induced by the embossed portions 18 in the intermediate base surface area 16B of the base surface 16 of the substrate 14 and have a shape corresponding to these embossed portions 18 (a shape substantially following the embossed portions 18).

At the surface of the coating material layer 20, substantially the same other-side indentations and projections 22C, which are surface indentations and projections 22, are formed uniformly in the other-side area 12C, with the other-side indentations and projections 22C induced by the particles of the coating material and not induced by the embossed portions 18 of the other-side base surface area 16C in the base surface 16 of the substrate 14, and configured with a shape not corresponding to these embossed portions 18 (a shape not following the embossed portions 18).

The depth of the one-side indentations and projections 22A is larger than the depth of the intermediate indentations and projections 22B, and the depth of the intermediate indentations and projections 22B is larger than the depths of the other-side indentations and projections 22C and the additional indentations and projections 22D. Moreover, the highest height positions of the one-side indentations and projections 22A, the intermediate indentations and projections 22B, the other-side indentations and projections 22C, and the additional indentations and projections 22D are the same or substantially the same.

As illustrated in FIG. 3, in cases in which the spacing of the embossed portions 18 on the base surface 16 of the substrate 14 is less than the specific value (in cases with the other-side area 12C and the additional area 12D), the surface indentations and projections 22 are not formed by the embossed portions 18 on the surface of the coating material layer 20, and the gloss of the surface of the coating material layer 20 is high. However, in cases in which the spacing of the embossed portions 18 is the specific value or larger (in cases with the one-side area 12A and the intermediate area 12B), the surface indentations and projections 22 are formed by the embossed portions 18 on the surface of the coating material layer 20 and the depth of the surface indentations and projections 22 becomes large as the spacing of the embossed portions 18 becomes large, leading to the gloss of the surface of the coating material layer 20 becoming low. Moreover, the specific value is smaller as the particle size of the coating material of the coating material layer 20 becomes smaller, facilitating the surface indentations and projections 22 being formed by the embossed portions 18 on the surface of the coating material layer 20.

Next, description follows regarding operation of the present exemplary embodiment.

In the coating structure 50 configured as described above, the embossed portions 18 are provided to the base surface 16 of the substrate 14, and the coating material layer 20 is formed by a single (same) coating material and covers the base surface 16.

The spacing of the embossed portions 18 in the one-side area 12A (the one-side base surface area 16A) is larger than the spacing of the embossed portions 18 in the intermediate area 12B (the intermediate base surface area 16B), and at the surface of the coating material layer 20, the depth of the one-side indentations and projections 22A corresponding to the embossed portions 18 in the one-side area 12A is larger than the depth of the intermediate indentations and projections 22B corresponding to the embossed portions 18 in the intermediate area 12B. Therefore, by making the visibility of the one-side indentations and projections 22A of the one-side area 12A greater than the visibility of the intermediate indentations and projections 22B of the intermediate area 12B, a difference can be achieved in the design of the coating material layer 20 between the surface of the one-side area 12A and the surface of the intermediate area 12B, enabling a change in design of the surface of the coating material layer 20 to be achieved even without using masking, and also enabling a change in design of the surface of the coating material layer 20 to be achieved even without using plural types of coating material, thereby facilitating a reduction in cost.

Furthermore, the one-side base surface area 16A and the intermediate base surface area 16B are adjacent on the base surface 16 of the substrate 14, and the one-side indentations and projections 22A and the intermediate indentations and projections 22B are adjacent on the surface of the coating material layer 20. Therefore, a parting portion (boundary) can be provided in the coating material layer 20 between the surface of the one-side area 12A and the surface of the intermediate area 12B. Moreover, the parting portion can be provided without using masking, enabling elimination of the need to provide an indentation portion along an outer perimeter of the masking on the base surface 16, enabling sharpness to be achieved in the parting portion, and enabling a highly attractive parting portion.

Moreover, the spacing of the embossed portions 18 in the intermediate area 12B (the intermediate base surface area 16B) is larger than the spacing of the embossed portions 18 in the other-side area 12C (the other-side base surface area 16C), and at the surface of the coating material layer 20, the depth of the intermediate indentations and projections 22B corresponding to the embossed portions 18 in the intermediate area 12B is larger than the depth of the other-side indentations and projections 22C not corresponding to the embossed portions 18 in the other-side area 12C. Therefore, by making the visibility of the one-side intermediate indentations and projections 22B of the intermediate area 12B greater than the visibility of the other-side indentations and projections 22C of the other-side area 12C, a difference can be achieved in the design in the coating material layer 20 between the surface of the intermediate area 12B and the surface of the other-side area 12C, enabling a change in design of the surface of the coating material layer 20 to be achieved even without using masking, and also enabling a change in design of the surface of the coating material layer 20 to be achieved even without using plural types of coating material, thereby facilitating a reduction in cost.

Furthermore, the intermediate base surface area 16B and the other-side base surface area 16C are adjacent on the base surface 16 of the substrate 14, and the intermediate indentations and projections 22B and the other-side indentations and projections 22C are adjacent on the surface of the coating material layer 20. Therefore, a parting portion (boundary) can be provided in the coating material layer 20 between the surface of the intermediate area 12B and the surface of the other-side area 12C. Moreover, the parting portion can be provided without using masking, enabling elimination of the need to provide an indentation portion along an outer perimeter of the masking on the base surface 16, enabling sharpness to be achieved in the parting portion, and enabling a highly attractive parting portion.

Moreover, the spacing of the embossed portions 18 in the one-side area 12A (the one-side base surface area 16A) is larger than the spacing of the embossed portions 18 in the other-side area 12C (the other-side base surface area 16C), and at the surface of the coating material layer 20, the depth of the one-side indentations and projections 22A corresponding to the embossed portions 18 in the one-side area 12A is larger than the depth of the other-side indentations and projections 22C not corresponding to the embossed portions 18 in the other-side area 12C. Therefore, by making the visibility of the one-side indentations and projections 22A of the one-side area 12A greater than the visibility of the other-side indentations and projections 22C of the other-side area 12C, a difference can be achieved in the design of the coating material layer 20 between the surface of the one-side area 12A and the surface of the other-side area 12C, enabling a change in design of the surface of the coating material layer 20 to be achieved even without using masking, and also enabling a change in design of the surface of the coating material layer 20 to be achieved even without using plural types of coating material, thereby facilitating a reduction in cost.

Furthermore, the coating material layer 20 is formed by the matt coating material. Therefore, a large difference can be achieved in the design of the surface of the coating material layer 20 due to the difference in the depth of the surface indentations and projections 22 of the coating material layer 20. Moreover, suppose that the coating material layer 20 were to peel off due to abrasion or the like, high gloss of the surface of the coating structure 50 can be suppressed by the embossed portions 18 of the base surface 16 of the substrate 14.

Note in the first exemplary embodiment and the second exemplary embodiment as described above, the depths of the embossed portions 18 formed on the base surface 16 (the substrate 14) at respective areas are set for example more than or equal to 2 μm and less than or equal to 500 μm, preferably, more than or equal to 2 μm and less than or equal to 50 μm. As described above, those values depend on the particle size of the coating material of the coating material layer 20.

Note that in the other-side area 12C on the surface of the coating material layer 20 in the first exemplary embodiment and the second exemplary embodiment as described above, by adjusting the particle size of the coating material of the coating material layer 20 or the like, the other-side indentations and projections 22C may be induced by the embossed portions 18 in the other-side base surface area 16C of the base surface 16 of the substrate 14 and with a shape corresponding to these embossed portions 18 (a shape substantially following the embossed portions 18). Therefore, on the surface of the coating material layer 20, not only is the depth of the intermediate indentations and projections 22B corresponding to the embossed portions 18 in the intermediate area 12B larger than the depth of the other-side indentations and projections 22C corresponding to the embossed portions 18 in the other-side area 12C, but the depth of the other-side indentations and projections 22C corresponding to the embossed portions 18 in the other-side area 12C is larger than the depth of the additional indentations and projections 22D not corresponding to the embossed portions 18 in the additional area 12D. Therefore, not only can a difference be achieved in design in the coating material layer 20 between the surface of the intermediate area 12B and the surface of the other-side area 12C, a difference can also be achieved in design in the coating material layer 20 between the surface of the other-side area 12C and the surface of the additional area 12D.

Furthermore, in the first exemplary embodiment described above, the depths of the embossed portions 18 are different in the one-side base surface area 16A, the intermediate base surface area 16B, and the other-side base surface area 16C of the base surface 16 of the substrate 14. Furthermore, in the second exemplary embodiment described above, the spacings of the embossed portions 18 are different in the one-side base surface area 16A, the intermediate base surface area 16B, and the other-side base surface area 16C of the base surface 16 of the substrate 14. However, both the depths and the spacings of the embossed portions 18 may be different in the one-side base surface area 16A, the intermediate base surface area 16B, and the other-side base surface area 16C of the base surface 16 of the substrate 14.

Moreover, in the first exemplary embodiment and the second exemplary embodiment described above, there may be a portion where embossed portions 18 is not provided on the base surface 16 of the substrate 14 in an area from the one-side base surface area 16A through the intermediate base surface area 16B to the other-side base surface area 16C. Providing a portion on the surface of the coating material layer 20 where the surface indentations and projections 22 are not induced by the embossed portions 18 enables an increase in variation in the design of the surface of the coating material layer 20.

Furthermore, in the first exemplary embodiment and the second exemplary embodiment described above, the one-side area 12A and the intermediate area 12B are adjacent, the intermediate area 12B and the other-side area 12C are adjacent, and the other-side area 12C and the additional area 12D are adjacent. However, the one-side area 12A and the other-side area 12C may be adjacent, the one-side area 12A and the additional area 12D may be adjacent, and the intermediate area 12B and the additional area 12D may be adjacent.

Moreover, in the first exemplary embodiment and the second exemplary embodiment described above, in the embossed portions 18 of the base surface 16 of the substrate 14 one or other or both of peak portions of the projections or bottom portions of the indentations may have a flat profile.

Furthermore, the coating material of the coating material layer 20 is opaque in the first exemplary embodiment and the second exemplary embodiment described above. However, the coating material of the coating material layer 20 may be transparent.

Moreover, in the matt coating material of the coating material layer 20, in a case in which the particle size becomes smaller than a fixed value smaller than in the first exemplary embodiment or the second exemplary embodiment, the particles enter into the indentations of the embossed portions 18 as the depth or spacing of the embossed portions 18 becomes smaller, and the surface of the coating material layer 20 reflects light in a diffused (scattered) manner leading to a lower gloss. However, the coating material follows the embossed portions 18 as the depth or spacing of the embossed portions 18 becomes larger, such that the surface of the coating material layer 20 becomes difficult to be affected by scattered reflection of light, and the gloss becomes higher.

What is claimed is:

1. A coating structure comprising:
a substrate that has a base surface at which base surface indentations and projections are provided, a first area and a second area being provided on the base surface such that the first area is adjacent to the second area, and a depth of the base surface indentations and projections in the first area being large and a depth of the base surface indentations and projections in the second area being small such that the depth of the base surface indentations and projections in the first area is larger than the depth of the base surface indentations and projections in the second area; and
a coating material layer that is formed from a single coating material and that covers the base surface, a depth of first indentations and projections corresponding to the base surface indentations and projections at a surface of the coating material layer, which surface corresponds to the first area, being large and a depth of second indentations and projections corresponding to the base surface indentations and projections at a surface of the coating material layer, which surface corresponds to the second area, being small such that the depth of the first indentations and projections is larger than the depth of the second indentations and projections.

2. The coating structure of claim 1, wherein a third area is provided on the base surface, a depth of the base surface indentations and projections in the third area is smaller than the depth of the base surface indentations and projections in the first area and larger than the depth of the base surface indentations and projections in the second area, and a depth of third indentations and projections corresponding to the base surface indentations and projections at a surface of the coating material layer, which surface corresponds to the third area, is intermediate between the depth of the first indentations and projections and the depth of the second indentations and projections.

3. A coating structure comprising:
a substrate that has a base surface at which base surface indentations and projections are provided, a first area and a second area being provided on the base surface such that the first area is adjacent to the second area, and a depth of the base surface indentations and projections in the first area being large and a depth of the base surface indentations and projections in the second area being small such that the depth of the base surface indentations and projections in the first area is larger than the depth of the base surface indentations and projections in the second area; and
a coating material layer that is formed from a single coating material and that covers the base surface, front indentations and projections corresponding to the base surface indentations and projections being provided on a surface of the coating material layer, which surface corresponds to the first area, and the front indentations and projections corresponding to the base surface indentations and projections not being provided on a surface of the coating material layer, which surface corresponds to the second area.

4. A coating structure comprising:
a substrate that has a base surface at which base surface indentations and projections are provided, a first area and a second area being provided on the base surface such that the first area is adjacent to the second area, and a spacing of the base surface indentations and projections in the first area being large and a spacing of the base surface indentations and projections in the second area being small such that the spacing of the base surface indentations and projections in the first area is larger than the spacing of the base surface indentations and projections in the second area; and
a coating material layer that is formed from a single coating material and that covers the base surface, a depth of first indentations and projections corresponding to the base surface indentations and projections at a surface of the coating material layer, which surface corresponds to the first area, being large and a depth of second indentations and projections corresponding to the base surface indentations and projections at a surface of the coating material layer, which surface corresponds to the second area, being small such that the depth of the first indentations and projections is larger than the depth of the second indentations and projections.

5. The coating structure of claim 4, wherein a third area is provided on the base surface, a spacing of the base surface indentations and projections in the third area is smaller than the spacing of the base surface indentations and projections in the first area and larger than the spacing of the base surface indentations and projections in the second area, and a depth of third indentations and projections corresponding to the base surface indentations and projections at a surface of the coating material layer, which surface corresponds to the third area, is intermediate between the depth of the first indentations and projections and the depth of the second indentations and projections.

6. A coating structure comprising:
a substrate that has a base surface at which base surface indentations and projections are provided, a first area and a second area being provided on the base surface such that the first area is adjacent to the second area, and a spacing of the base surface indentations and projections in the first area being large and a spacing of the base surface indentations and projections in the second area being small such that the spacing of the base surface indentations and projections in the first area is larger than the spacing of the base surface indentations and projections in the second area; and
a coating material layer that is formed from a single coating material and that covers the base surface, front indentations and projections corresponding to the base surface indentations and projections being provided on a surface of the coating material layer, which surface corresponds to the first area, and the front indentations and projections corresponding to the base surface indentations and projections not being provided on a surface of the coating material layer, which surface corresponds to the second area.

7. The coating structure of claim 1, wherein the coating material layer is formed from a matt coating material.

8. The coating structure of claim 3, wherein the coating material layer is formed from a matt coating material.

9. The coating structure of claim 4, wherein the coating material layer is formed from a matt coating material.

10. The coating structure of claim 6, wherein the coating material layer is formed from a matt coating material.
